(19) United States
(12) Patent Application Publication
(10) Pub. No.: US 2015/0244684 A1
(43) Pub. Date: Aug. 27, 2015

(54) DATA SECURITY MANAGEMENT SYSTEM

(71) Applicant: NWSTOR LIMITED, Hong Kong (CN)

(72) Inventors: Chan Yiu Ng, Hong Kong (CN); Zhengshan Yan, Hong Kong (CN); Shing Yee Chu, Hong Kong (CN); Kam Tim Cheng, Hong Kong (CN); Ting Him Lee, Hong Kong (CN); Dennis Chung Young, Hong Kong (CN)

(21) Appl. No.: 14/426,993

(22) PCT Filed: Sep. 10, 2013
(86) PCT No.: PCT/CN2013/083241

§ 371 Date: Mar. 10, 2015

Related U.S. Application Data
(60) Provisional application No. 61/699,274, filed on Sep. 10, 2012.

(51) Int. Cl. H04L 29/06

(52) U.S. Cl. CPC H04L 63/0428; H04L 63/062

(57) ABSTRACT

The present patent application is directed to a data security management system. The system includes a security server configured to store an encryption key to encrypt a file or any data and a decryption key to decrypt the file or the data; a first computing device configured to send an access authorization list with authorization limit to the security server, request an encryption key from the security server, and encrypt the file or data with the encryption key received from the security server; a second computing device configured to request a decryption key from the security server and decrypt the encrypted file with the decryption key received from the security server; and a cloud storage configured to share the file between a first user using the first computing device and a second user using the second computing device.

### CROSS-REFERENCE TO RELATED APPLICATIONS

This application claims the benefit of U.S. Provisional Patent Application No. 61/699,274 filed on Sep. 10, 2012, the contents of which is hereby incorporated by reference.

### FIELD OF THE PATENT APPLICATION

The present patent application generally relates to data management technologies and more specifically to a data security management system that provides extra security especially for cloud computing applications and allows users to control data security of their data residing in any device from anywhere at any time.

### BACKGROUND

More than 60% of CIOs of companies around the world worry about the security of cloud computing, especially cloud data security. One of the major concerns about cloud data security is that the data residing in Cloud Data Centers can be accessed by employees and third party contractors of the Cloud Data Center service providers. Therefore, it is desired to allow users to control data security of their data residing in any device, which may include Cloud Data Centers, End-Point devices, USB devices, and etc. from anywhere at any time.

### SUMMARY

The present patent application is directed to a data security management system. The system includes a security server configured to store one or more encryption key(s) to encrypt one or more file(s) or any data and one or more decryption key(s) to decrypt the corresponding encrypted file(s) or the data; one or more first computing device(s) configured to send an access authorization list with authorization limit to the security server, request an encryption key from the security server, and encrypt one or more file(s) or data with the encryption key received from the security server; one or more second computing device(s) configured to request a decryption key from the security server and decrypt one or more encrypted file(s) with the decryption key received from the security server; and a cloud storage or any data storage configured to share the file between a first user using the first computing device and one or more second user(s) using the second computing devices. The security server is configured to determine whether to send the decryption key to the second computing device upon verifying whether the second user is on the access authorization list and within the authorization limit.

### BRIEF DESCRIPTION OF THE DRAWINGS

FIG. 1 illustrates a computer-based application as a part of a data security management system in accordance with an embodiment of the present patent application.

FIG. 2 illustrates the operation of a data security management system in accordance with an embodiment of the present patent application.

FIG. 3 shows the infrastructure architecture of a data security management system in accordance with an embodiment of the present patent application.

FIG. 4 shows a process of communication between the uSav App and the Security Server to accomplish file encryption in a data security management system in accordance with an embodiment of the present patent application.

FIG. 5 shows a process of communication between the uSav App and the Security Server to accomplish file decryption in a data security management system in accordance with an embodiment of the present patent application.

### DETAILED DESCRIPTION

Reference will now be made in detail to a preferred embodiment of the data security management system disclosed in the present patent application, examples of which are also provided in the following description. Exemplary embodiments of the data security management system disclosed in the present patent application are described in detail, although it will be apparent to those skilled in the relevant art that some features that are not particularly important to an understanding of the data security management system may not be shown for the sake of clarity.

Furthermore, it should be understood that the data security management system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

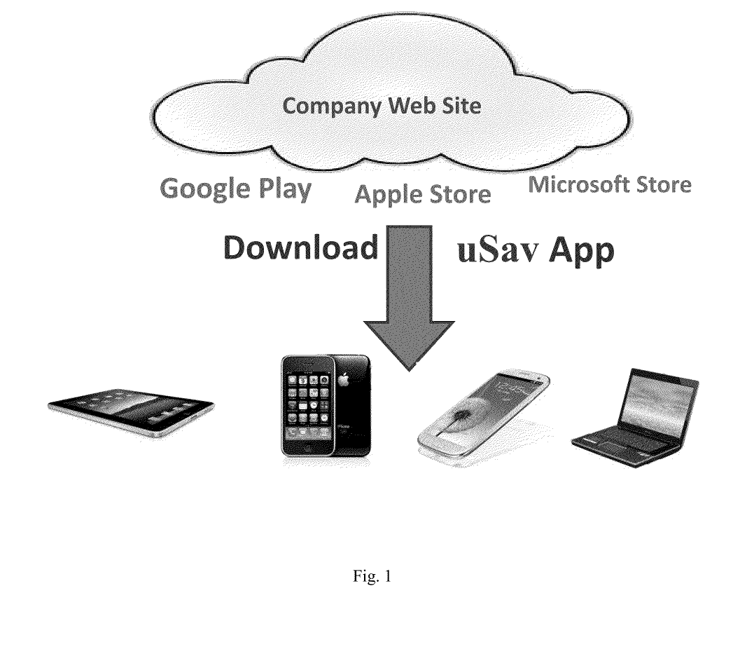

FIG. 1 illustrates a computer-based application as a part of a data security management system in accordance with an embodiment of the present patent application. Referring to FIG. 1, one or more user(s), each downloads the application, also referred to as the uSav App hereafter, to one or more device(s), such as smart phones, laptops, iPads, tablets, and etc. from App Stores (such as Google Play, Apple Store, and Microsoft Store, etc.) or a website (the “nwStor Website” as in FIG. 1). Before using the data security management system, each user is required to register and set up an account. In this embodiment, the registration information required from user is the following:

1. Family Name and Given Name (non-validated to protect privacy)

2. Email Address (also used for password recovery)

3. User ID: It has to be unique within the system's database (the user ID can be but not limited to the user's email address).

4. Choice of authentication method (the authentication method will be described hereafter in more detail)

a. Charge Account Information: This is not required on initial registration. It is required only after user has used up the complementary free usage amount. The information includes but is not limited to credit card number, Paypal account number, bank account number, and etc.

5. Personal questions and answers for password recovery purposes.

No verification of user information will be performed to protect user privacy. After user registration has been completed, a computer-generated password will be sent to the user's email address. The password can be changed after logging into the uSav App.

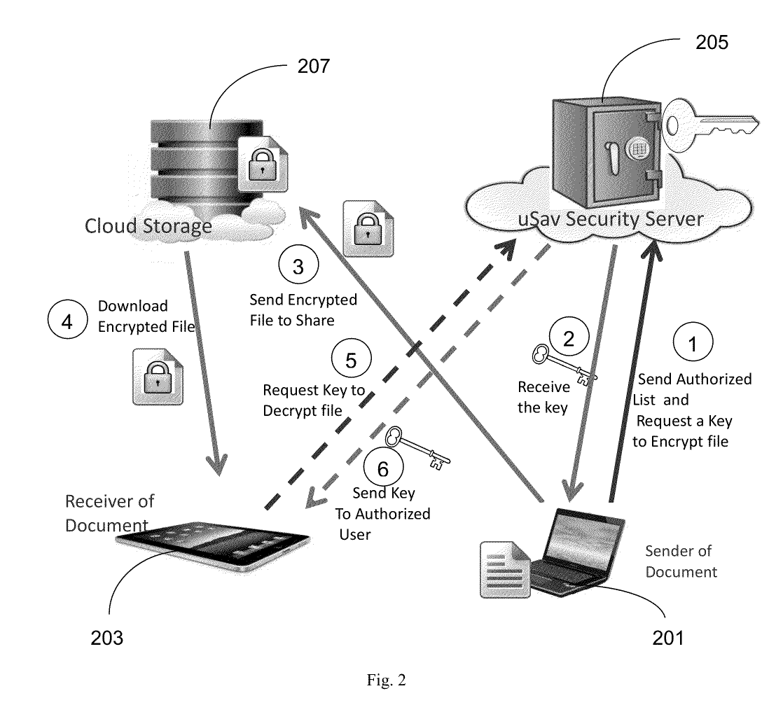

FIG. 2 illustrates the operation of a data security management system in accordance with an embodiment of the present patent application. Referring to FIG. 2, both a Sender 201 and a Receiver 203 have downloaded the uSav App and have registered with the system. As shown in FIG. 2, in step 1, the sender 201, who is the file owner logins with the uSav App on his device and identifies which file to secure. The sender 201 also provides an Access Authorization List of some of the system's registrants (also referred to as the uSav registrants) who are authorized to open and read the file. The uSav App, which is transparent to the sender 201, will then request an encryption key from a security server 205 (also referred to as the uSav Security Server). At the same time, the uSay App also sends the Access Authorization List (as parameters) to the security server 205. The security server 205 saves the user data security requirements and controls information of the users' data by controlling the encryption key according to the users' instructions.

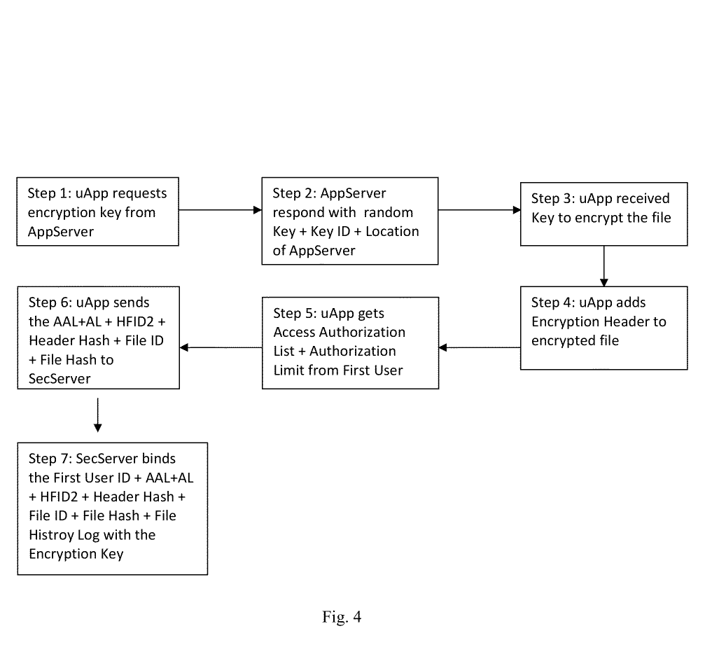

In step 2, the uSav Security Server 205 will then send the uSav App (i.e. the sender 201) a copy of a newly and randomly generated encryption key. The Access Authorization List is attached to (or bound with) the encryption key and both are saved in the security server 205. (There are more information bound with the encryption key as will be shown later during the encryption process as shown in FIG. 4.) In step 3, after the uSav App has encrypted the file, the owner sends the encrypted file to his friends who have registered with the system to share the file with them. The sharing can be achieved, typically through Internet, intranet, wire, wireless or combination of these network services, by attaching the encrypted file in emails, messages, or putting the encrypted file in a Cloud Drive (or a cloud storage) 207, such as one provided by Google Drive, Dropbox, Sky Drive, and etc. The sharing can also be done through physical storage devices, such as USB memory devices, USB memory sticks, or any physical devices capable of data storage. In step 4, the receiver 203 downloads the encrypted file through the Internet (or any type of network), or receives the encrypted file through a physical storage device. In step 5, one of the receivers 203 logs in to the uSav App, and requests the uSav App to decrypt the file. The uSav App, being transparent to the receiver 203, sends a request for decryption key to the uSav Security Server 205 with the requester's (the receiver 203's) ID and Password as parameters of the request. In step 6, the Cloud Key Manager (in the security server 205) checks to make sure the requester's (the receiver 203's) ID is in the authorization List (as mentioned in the steps 1 and 2 above) and then sends the decryption key to the uSav App at the receiver 203's end, and the uSav app will use the decryption key to decrypt the file.

In the above embodiment, there can be a large number of uSav registrants. Each of the registrants 201 can be a sender of one or more encrypted document(s). Any uSav registrants can be one of the receivers 203 of the encrypted document. Secure collaboration and Sharing of documents are thus achieved among the registrants.

In the above embodiment, a data security management system is provided. The data security management system includes: a security server configured to store large number of encryption keys to encrypt large number of files and a large number of decryption keys to decrypt the corresponding encrypted files; a first computing device configured to send an access authorization list to the security server, request an encryption key from the security server, and encrypt the file with the encryption key received from the security server;

a second computing device configured to request a decryption key from the security server and decrypt the encrypted file with the decryption key received from the security server; and

a cloud storage, or any data storage configured to share the file between a first user using the first computing device and a second user using the second computing device. The security server is configured to determine whether to send the decryption key to the second computing device upon verifying whether the second user is on the access authorization list. By controlling the access authorization list of a encryption key anytime anywhere, the sender controls the access right of who can open the corresponding encrypted file anytime anywhere.

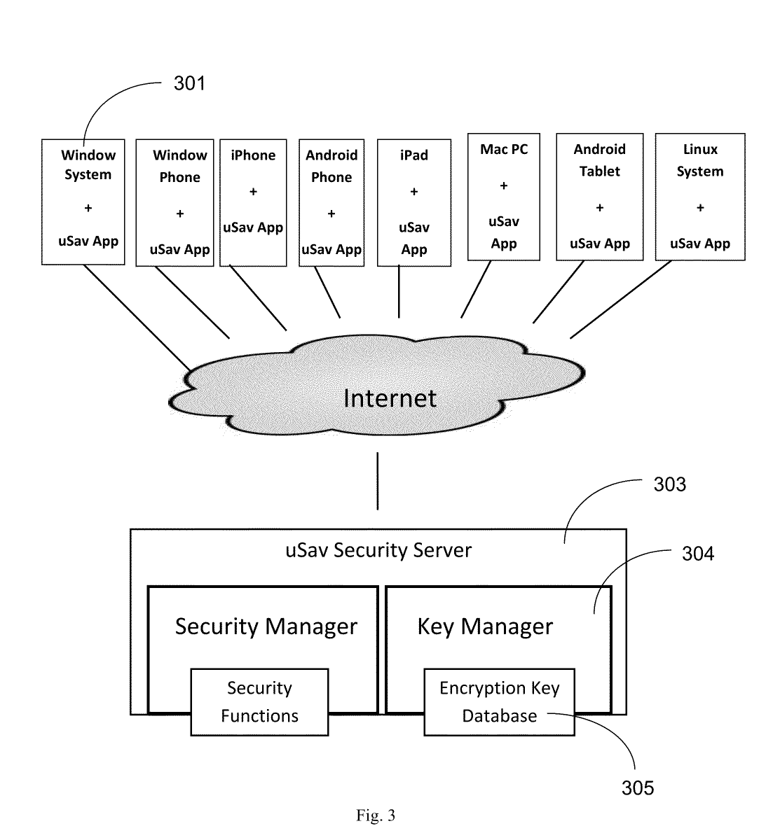

FIG. 3 shows the infrastructure Architecture of a data security management system in accordance with an embodiment of the present patent application. Referring to FIG. 3, all the portable and desktop devices 301 (also referred to as the App devices 301) installed with the uSav App communicate with the uSav Security Server 303 through the Internet or an intranet. The uSav Security Server 303 can be located in any Data Center, including Cloud Computing Data Center, or any location as long as the uSav App can communicates with it. The communication can be based on Wi-Fi, Ethernet, Internet, intranet, etc. Communication between the uSav App and uSav Security Server 303 is implemented through pre-defined API.

Each of the uSav enables each user to do file/data encryption, decryption and security management of his/her data from anywhere anytime. If both the uSav Security Server 303 and the App devices 301 are restricted within a company or organization; the communication can be implemented through Intranet. If the App devices 301 need to be mobile and can be physically located anywhere in the world, the Security Server 303 needs to be accessible through the Internet.

The Security Server 303 can be a Virtual Security Server operating from any Cloud Computing Service Provider's Data Center or user's own location (data center). The Security Server 303 can also be a real dedicated server running at the user's own location or any other location. The Security Server should be in High Availability mode or Cluster Mode without a single point of failure.

The user can choose different levels of security for authentication. The choice is offered during registration or change of the user profile settings. There are 3 choices:
1. User ID+Password
2. User ID+Password+Login Picture
3. User ID+Password+OTP (One Time Password)
4. User ID+Password+Login Picture+OTP (One Time Password)

User ID and password is the minimum required authentication method. The user chooses the password. The user is required to type the password twice to verify the password. An email will be sent to the user's email address. The user has to follow the email instruction to activate the account. After the user chooses his/her password, the uSav App gives a security rating of the password:
1. Low (minimum password requirement): at least 8 characters with at least one alphabet and one number;
2. Medium: at least 8 characters with at least one uppercase alphabet, one lowercase alphabet and one number;
3. High: at least 8 characters with at least one uppercase alphabet, one lowercase alphabet, one number and one symbol.

There are other choices of authentication methods in the market which can be integrated into uSav security management system.

For password recovery, after the user correctly answers a few pre-set questions for verification, a new computer generated password is sent to the user's email. A USB/Smartphone or software generated OTP (One Time Password) can be used for further authentication.

Just like an email address list, each user can set up a list of uSav contact list. The required information for each contact is the following:

1. Name of Contact (optional);

2. ID of Contact: This has to be provided by the contact or the user's friend (in this embodiment, the friend's email address is used as the ID);

3. Note/comment area of the Contact (not a required input item for the user);

4. Email address of the Contact (not a required input item for the user).

While new contact can be added, existing contacts can be edited or deleted. One or more contact(s) can be grouped together under a Group Name. A Group can be edited. For a Group,

1. contact members in that Group can be modified, added to or deleted from the Group;

2. the Group name can be modified;

3. the Group can be deleted;

4. new Groups can be added.

The user is allowed to create a contact who has not registered with uSay. During the display of the contact list, non-registered contacts will be shown with a different shade or color. In the embodiment, when the file owner uses the uSav App to encrypt a file, he/she can specify a list of contacts, which are authorized to decrypt the encrypted file. This list of authorized contacts is the AAL (Access Authorization List). AAL may contain name(s) of contact person(s) and/or contact group(s). If the AAL is empty, only the file owner is authorized to do the decryption. One or more non-registered contact(s) can be added to the AAL. In this case, an email will be sent to this non-registered contact to notify him/her to register with the system.

Each AAL is bound with a corresponding unique encryption key. It is noted that one or more file(s) may be encrypted by the same encryption key. There is an advantage of using one key for multiple files such as one key for a subfolder. In this case all the files have the same access right for contacts in the AAL.

There are three types of authorizations in this embodiment: file owner authorization, read authorization to non-owner, and hierarchical multi-layer authorization. In file owner authorization, the file owner is the only authorized person when AAL is empty. The file owner can read (actually decrypt) and grant read authorization to other contacts. The file owner can delete the file permanently, which will be described hereafter in more detail. The file owner can view the History Log of the file. The user can view his/her own Operation Log, which will also be described hereafter in more detail. The file owner can change the AAL of the file. In this embodiment, the internal time zone of the uSav App is set to standard UTC 0. All the logs will be shown as in UTCO time zone.

The decryption (or read) authorization to each non-owners (or receiver) in the access authorization list of a particular encryption key also has a Authorization Limit as defined below:
1. Limited by Start Time; when start time is 0, authorization start immediately. Before the Start Time, encryption key will not be sent to the receiver.
2. Limited by End Time; after passing the End Time, the encryption key will not be sent to the receiver. The End Time can be forever.
3. Number of decryption (or read) allowed which can range from 1 to n, where n is >1.
When the number of times the encryption key sent to the receiver has reached n, the security server will not honor any more key request from the receiver.

In hierarchical multi-layer authorization, which is used for an organization or institution, a policy can be set up, such that the manager or supervisor of a group can have access and decryption right to all encrypted files or data created by his/her supervised members and groups regardless whether access authorization have been granted by the file or data owner. Depending on the policy of the organization, the supervisor can have the same or limited rights as the file owner.

There can also be a “Super User” who can decrypt all encrypted files in the organization.

It is also desirable to have file owner or someone who can do encryption only, but nothing else.

This is the case for survey workers who gather information, encrypt and save the information only.

The owner of an encrypted file can display the AAL with Authorization Limit of each authorized user (AAL+AL) of the encrypted file. Non-registered contact on the list will be shown in different shade or color. For security purposes, any receiver of the encrypted file will not be able to see the AAL+AL of the encrypted file. In other words, in the embodiment, the second computing device, i.e. the file receiver, is restricted from receiving the access authorization list.

The file owner can change the AAL+AL of any encrypted file anytime. Since AAL+AL corresponds to a unique encryption key with a unique Key ID, which will be described hereafter in more detail, changing the AAL+AL of a file is actually changing the AAL+AL corresponding to an encryption key. Since multiple files may have been encrypted by a single key, changing the AAL+AL of a single file may effectively change the AAL+AL of multiple files encrypted by the same key.

Each file is encrypted by AES 256 bit CBC encryption algorithm with variable initialization value. Other encryption algorithms may be used, such as 3DES and etc. Multiple encryptions with multiple keys using different encryption algorithms may be deployed as well. In this embodiment, the file type extension of the uSav encrypted file is “.usav”, which is added to the name of the original file. The file icons of the encrypted files are also unique. The system is able to encrypt any selected file in a supported device. The selection can be made to a single file, multiple files or a folder/subdirectory. If the file owner has not logged in successfully, the selection process will invoke the login process automatically.

When more than one file is selected for encryption, the owner may choose one single key for all files or one unique key per file. When one single encryption key is selected, the AAL+AL of the key will govern the access control of all these encrypted files. When one unique key per file is selected, each one of the multiple files is to be encrypted by a unique key. In other words, the owner may choose whether all the files to be encrypted have one AAL+AL or each AAL+AL will be set up individually for each file.

The file owner can specify the path location for storing the newly encrypted file or folder/subdirectory. The default path location will be the same as the original (unencrypted) selected clear text file(s) or subdirectory. For non-folder encryption, each of the encrypted file will appear next to the (unencrypted) clear text file (default location).

In this embodiment, decryption will restore the encrypted file back to its original clear text file while the file “.usav” is removed from the decrypted file. The process of selecting files to be decrypted is very simple, transparent and user friendly. A user can select a single file, multiple files or a folder/subdirectory to be decrypted. If the user has not logged in successfully, the selection process will invoke the login process automatically. The file owner can specify the path location to store the newly decrypted file. The default path location will be the same as the original selected encrypted file(s) or subdirectory. For non-folder decryption, each decrypted file will appear next to the encrypted file.

A file owner can delete an encrypted file permanently. Any existing copy of the encrypted file will never be opened again by anyone, even the file owner. The system achieves this by deleting the encryption key of the file. Since multiple files may have been encrypted by the same key, all these files will not be able to be opened if the key is deleted. It is noted that even though the encryption key may have been deleted, other information related to the key, such as a log of the key (or file), will still exist.

The encrypted file owner can display a history log (also referred to as the File Secure Log) of the encrypted file. The history log is actually a interpretation of the log of the corresponding encryption key maintained by the Key Manager (referring to 304 in FIG. 3) of the uSav Security Server 205 (referring to FIG. 2). The key may be used by more than one file. In this case the log includes events of multiple files. Each of the log event may include the following information:
1. Time and date of each log event (for example the first event is key creation).
2. ID and Type of Decryption Device:
   a. Smart device Type & model, ID, Serial number, phone number. SIM ID, device owner, etc.
3. Location, such as through GPS
4. Owner of encryption key, so are files that have been encrypted with this encryption key.
5. User ID of event action: This can be the owner or any user
6. Event Action
   a. Key creation: In this embodiment, this is interpreted as file encryption, since the key is used to do file encryption.
   b. AAL+AL set up: This is to set up list of users permitted to access the file key and Authorization Limit to each of them.
   c. Change of AAL+AL
   d. Key request for file decryption, result can be successful or failed with error code: This can be interpreted as the action of file decryption, since the App in user's device request for the key only when it is ready to do the file decryption
   e. Decryption Completed Successfully or Unsuccessful with error reason
   f. Key request for file encryption: result is successful or failed with reason.
   g. Encryption Completed Successfully or Failure with error code
   h. File permanent deletion (This is deletion of the encryption key): result is Successful or failed with error code.
   i. Display of History log of a file: The display of encryption key history log will be shown instead
7. Event Content: depending on Event Action
   a. Name of file, folder or subdirectory: This is for encryption or decryption event.
      i. If it is a single file encryption per key, it is the name of the file to be encrypted.
      ii. If it is a group of files to be encrypted by a single key, it is the name of the first file plus indication of multiple files.
      iii. If it is a folder or subdirectory to be encrypted by a single key, it is the name of the folder or subdirectory plus indication of folder or subdirectory.
   b. Encryption Key size and type of encryption and algorithm
      i. In this embodiment, key sizes can be 64 bits, 96 bits, 128 bits and 256 bits for symmetric-key type encryption; and 1024 and 2048 bits for public-key type encryption.
   c. File and Key ID
   d. Initial AAL+AL
   e. New AAL+AL or change to AAL+AL

For each user ID of the system in this embodiment there is a user operation log (also referred to as the User ID Secure Log). The user ID operation log includes all the operation events related to that particular user. The user ID each of the operation log event may include the following information:
1. Time and date of each log event (for example the first event is user registration)
2. ID and Type of Decryption Device:
   a. Smart device Type & model, ID, Serial number, phone number. SIM ID, device owner, etc.
3. Location through GPS
4. User ID of event action
5. Event Action
   a. User Registration with successful or failed error reason
   b. User Log-in with successful or failed error reason
   c. User Log-out with successful or failed error reason
   d. User Forced Log-out due to time out
   e. Display of user history log with successful or fail status
6. Event Content: depending on Event Action

Referring to FIG. 3, communication between the uSav App (also referred to as the uApp hereafter) and uSav Security Server 303 (also referred to as the SecServer hereafter) is implemented through pre-defined API. FIG. 4 shows a process of communication between the uApp and the SecServer to accomplish file encryption. The actual encryption process is done at the user device, such as PC, Smart Phone, Tablet, etc. The assumption is the authentication of the user has been completed successfully. The File History Log will also be updated as described before.

Referring to FIG. 4, in step 1, the uApp in user's device, such as an iPhone, requests (using API) an randomly generated encryption key from the SecServer through a network (which can be the Internet, intranet, etc.) connection. The parameters being sent to the SecServer include name of file or folder or subdirectory to be encrypted, user device type, model and ID, location (GPS) and the encryption key's type (symmetric or public key encryption), algorithm (AES, 3DES, Twofish, etc.) and size.

In step 2, the SecServer, after receiving the request for encryption key, generates a randomly generated encryption key and assigns a Key ID to the encryption key. The Encryption Key, Key ID, User ID (identified from the communication protocol), and Date and Time are saved in a data storage, such as an Encryption Key Database (referring to 305 in FIG. 3) in the key manager (304 in FIG. 3) of the SecServer (303 in FIG. 3). More specifically, the SecServer responds to uApp's request in step 1 with:
1. Encryption Type, Encryption Algorithm, Encryption Key and its size;
2. A unique Key ID, which is used to identify the encryption key
3. Date and time of the Encryption Key generation;
4. Internet Location Address of where the Encryption Key Database can be found, which is the Internet Location Address of the SecServer in this embodiment. The Internet Location Address can be IP address, Domain Name, or any format such that the SecServer can be located through the Internet. For example the SecServer can be located in a Public Cloud.

In step 3, the uApp generate a harsh for the file before encryption. The Hash algorithm can be MD5, SHA-1, etc. This is to verify the integrity of the decrypted file in the future. The uApp, after receiving the response from the SecServer, encrypts the file(s) designated by the user. The encryption method is determined by the type of the uApp and can also be pre-configured by the user.

In step 4, at the end of applying the encryption algorithm to the file data to generate the encrypted data, a file header is added to the encrypted file data by the uSav app. The file header includes the following information:
1. Date and time as received from the SecServer in step 2;
2. File ID: A randomly generated unique ID for the file. To avoid the duplication of the File ID, a 32byte randomly generated ID is used in this embodiment;
3. Key ID received from the SecServer in step 2, which is used to identify the encryption key in the future;
4. Encryption/decryption algorithm used, such as AES 256, 3DES, and etc;
5. Internet Location Address received from the SecServer in step 2, which is used for future communication with SecServer;
6. Header Format identifier to identify what parameters, such as those listed above, are included and how the header parameters are arranged.
   a. The Header format identifier actually tells how the header information is hiding within the encrypted file. The Header Format identifier also tells whether and how the Header parameters are encrypted. The Header Format ID is divided into two parts, HFID1 and HFID2. HFID1 stays with encrypted file while HFID2 will be send to Secure Server as described in Step 6. HFID1 should be able to identify the Key ID and Internet Location of SecServer as described in item 3 and 5 above.

A header hash of the file header with the above parameters is generated with hash algorithm by the uSav app. The Hash algorithm can be MD5, SHA-1, etc. This is used to detect integrity of the header. The newly encrypted file will have “.usav” as a new file extension.

In step 5, after adding the header to the encrypted file, the uApp requests the user to provide a list of friends' IDs authorized to open and read the file. This list is the Access Authorization List (AAL) as described before.

In step 6, the uApp sends the SecServer the following parameters:
1. the Key ID from step 2, which will be used as the communication ID in the future connection;
2. AAL+AL;
3. File ID as described in Step 4.
4. HDF2, Header Format Identifier part 2, as described in Step 4.
5. File Hash (and Hash algorithm) generated in step 3.
6. Header Hash (and Hash algorithm) generated in step 4.

In step 7, the SecServer binds the following parameters with the Key ID:
1. Creation Time
2. Encryption Key, type and size
3. User ID, identified from the communication protocol with the user;
4. AALwith limit of authorization of each authorized user;
5. File ID;
6. File HDF2, i.e. Header Format Identifier part 2 as described in step 4;
7. File Hash and Hash Algorithm used
8. Header Hash value and Hash Algorithm used, such as MD5, from step 6;
9. File Secure Log as described before.

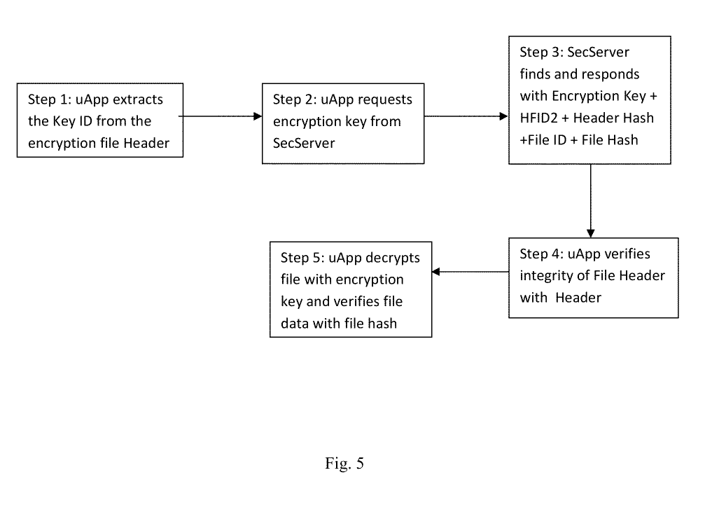

FIG. 5 shows a process of communication between the uApp and the SecServer to accomplish file decryption in a data security management system in accordance with an embodiment of the present patent application. In this process, the File Secure Log will also be updated. Referring to FIG. 5, in step 1, after the user identifies which file to decrypt, the uApp extracts the Key ID and Internet Location Address from the File Header as aforementioned by using a HDF1, i.e. Header Format Identifier part1.

In step 2, the uApp requests the encryption key from the SecServer by sending it to the Internet Location Address with the Key ID as a parameter. In step 3, the SecServer uses the Key ID to locate a corresponding Encryption Key Record in the encryption key database. The SecServer checks the AAL+AL, which is bound with the key ID, to see if the requester is authorized to open and see the file. If not, the Secserver will reject the request.

If yes, it will respond with the following parameters to the requester:
1. Encryption Key
2. HFID2, i.e. Header Format ID part 2
3. File ID
4. File Hash and Hash Algorithm used
5. Header Hash and Hash Algorithm used

After receiving the parameters from the step 3, in step 4, the uApp generates the original Header according to HFID2, and generate a new Header Hash with the Hash Method (received in step 3). The uApp compares the new Header Hash with the one received from the SecServer in step 3 so as to verify the integrity of the file header of the file to be decrypted. If they are the same, it means the File Header has not been changed and the uApp will then proceed with step 5.

If the Header Hashes are not the same, it means the File Header is not the same as before and cannot be used reliably so that as a result the decryption request from the user will be rejected.

In this case the file ID of the generated header and the one received from SecServer are compared. It they are not the same, quite possible that the wrong key has been received from SecServer. If they are the same, most probably the encrypted data and/or its file header information has been changed.

In step 5, the uApp uses the encryption key provided by the SecServer to decrypt the file using the decryption method identified in the file header as mentioned before. The uApp will generate a new File Hash (with the Hash Method received in step 3) of the decrypted file. The uApp compares the new File Hash with the one received from the SecServer in step 3 so as to verify the integrity of the decrypted file. If they are the same, it means the file has not been changed and the uApp will then proceed with step 5. If the Header Hashes are not the same, it means the file has been changed and decryption is failed.

In this embodiment, the File Header is created by the uApp in the user's own device. A more secure method is to create the File Header by the SecServer. In this case, the complete File Header for the encrypted file will be created by the SecServer during the encryption process and sent to the uApp. The uApp needs to send the necessary parameters to the SecServer to create the File Header. The uApp does not know the format of data and parameters in File Header. To decrypt a file, the uApp has to send the complete File Header to the SecServer. The SecServer will do the integrity checking with Header Hash. If the Header Hash passes the integrity check, the SecServer will send the Encryption Key (therefore the Decryption Key) and Encryption Method (therefore the Decryption Method) for the uApp to do the decryption.

The AAL+AL can be changed anytime anywhere through internet by file owner, so the access right of anyone can be added, deleted or modified in the AAL+AL anytime anywhere by mobile device as long as there is network to access the SecServer by the end device.

With the system provided by this embodiment, collaboration between different users can also be achieved as the following. The user can indicate to the uSav App that multiple folders are are “Collaboration Folders”. Each Collaboration Folder can be a folder in a normal File System or in Cloud Storage, such as those in Google Drive. All files and subfolders under each of the “Collaboration Folder” may have the same pre-setup AAL+AL. All current files and new files in the Collaboration Folder are secured and encrypted by the uSav App and can be shared by users in the AAL. For a user, all plain-text files saved in the Collaboration Folder will be automatically encrypted by uSav transparently without direct request from user. All encrypted files opened by the user in the Collaboration Folder will be decrypted by uSav automatically and transparently without direct request from the user.

In another embodiment, a data security management system includes: a first computing device; a second computing device; and a security server in communication with the first and second computing devices. The first computing device is configured to send an access authorization list with authorization limit to the security server and request an encryption key from the security server.

The security server is configured to send the encryption key to the first computing device. The first computing device is configured to encrypt a file with the encryption key and share the encrypted file with the second computing device. The second computing device is configured to request a decryption key from the security server. The security server is configured to send the decryption key to the second computing device after verifying that the second computing device is being used by a user on the access authorization list and within the authorization limit. The second computing device is configured to decrypt the encrypted file with the decryption key.

In yet another embodiment, a data security management method is provided. The method includes: sending an access authorization list to a security server from a first computing device and requesting an encryption key from the security server by the first computing device; sending the encryption key to the first computing device from the security server; encrypting a file with the encryption key by the first computing device and sharing the encrypted file with a second computing device; requesting a decryption key from the security server by the second computing device; sending the decryption key to the second computing device after verifying that the second computing device is being used by a user on the access authorization list and within the authorization limit by the security server; and decrypting the encrypted file with the decryption key by the second computing device.

In the systems and method provided by the above embodiments, the uSav App is located at end-devices, smart phones, PCs, tablets, servers and etc. After a file has been encrypted, it can be saved or sent to anywhere at the user's choice, including any Cloud Data Center, i.e. public cloud or private cloud; any end-device such as Smart phones, tablets, PCs, etc.; personal PC or any storage device without sharing but just to secure the files for the user himself; other people receiving an email or message with the encrypted file as an attachment; or any server, NAS, USB, SD card, or storage devices. Since encrypted data can be saved at Cloud Data Center, the Cloud Data Security is achieved. The system lets customers to control his/her Cloud Data Security, so that even Cloud Data Center IT Administrators will not be able to access the clear text data, as Cloud Data Center IT administrators do not have access to encryption keys.

Furthermore the SecServer most probably is not located at the same Data Center. Since data at end-points, smart phone, tablets, PCs, USB devices, etc., are secured as aforementioned, end-point data security is achieved as well. The uSav App allows the file owner to change the Access Authorization List anytime anywhere, even after the encrypted file has been sent out.

The security level of files protected by the system is extremely high for the following reasons.

Both clear text and encrypted data are kept by the file owner, but the encryption key is kept separately by the uSav Security Server. This separates the physical and logical locations of encrypted data and encryption key. It is difficult for any hacker or organization to access data from a single physical or logical location. There is no exact known location of where the encrypted data being stored. The user has the freedom to store the encrypted data anywhere or change the location anytime. The uSav Security Server contains encryption keys but not the data.

Hackers, anyone or any organization will not be able to access the data from the system alone.

Even the uSav Security Server and its administrator have no access to the user's file data. The encryption is done by the uSav App at the user's local devices.

While the present patent application has been shown and described with particular references to a number of embodiments thereof, it should be noted that various other changes or modifications may be made without departing from the scope of the present invention.

1. A data security management system comprising:
a security server configured to store an encryption key to encrypt a file or any data and a decryption key to decrypt the file or the data;
a first computing device configured to send an access authorization list with authorization limit to the security server, request an encryption key from the security server, and encrypt the file or data with the encryption key received from the security server;
a second computing device configured to request a decryption key from the security server and decrypt the encrypted file with the decryption key received from the security server; and
a storage configured to share the file between a first user using the first computing device and a second user using the second computing device; wherein:
the security server is configured to determine whether to send the decryption key to the second computing device upon verifying whether the second user is on the access authorization list and within the authorization limit.

2. The data security management system of claim 1, wherein the first computing device, the second computing device, the storage, and the security server are connected with the Internet and/or intranet.

3. The data security management system of claim 1, wherein communication between the first and second computing devices and the security server is respectively implemented through pre-defined API.

4. The data security management system of claim 1, wherein each access authorization list with authorization limit is bound with a unique encryption key.

5. The data security management system of claim 1, wherein the second computing device is restricted from receiving the access authorization list.

6. The data security management system of claim 1, wherein when requesting an encryption key from the security server, the first computing device is configured to send a file name and the encryption key's type and size to the security server.

7. The data security management system of claim 1, wherein the security server comprises a key manager with an encryption key database, the security server is configured to assign a key ID to the encryption key, while the encryption key and the key ID are saved in the encryption key database.

8. The data security management system of claim 7, wherein when encrypting the file, the first computing device is configured to add a file header to the encrypted file and generate a header hash of the file header, the file header comprises a randomly generated unique file ID and the key ID.

9. The data security management system of claim 8, wherein after encrypting the file, the first computing device is configured to send the key ID, the access authorization list, and the header hash to the security server.

10. The data security management system of claim 9, wherein the security server is configured to bind a user ID of the first user, the access authorization list, and information about the header hash with the key ID.

11. The data security management system of claim 10, wherein when decrypting the encrypted file, the second computing device is configured to extract the key ID from the file header.

12. The data security management system of claim 11, wherein when requesting the decryption key from the security server, the second computing device is configured to send the key ID as a parameter to the security server.

13. The data security management system of claim 12, wherein the security server is configured to locate a corresponding encryption key record in the encryption key database with the key ID, to verify whether the second user is on the access authorization list bound with the key ID, and upon valid verification send the encryption key and the corresponding header hash information to the second computing device.

14. The data security management system of claim 13, wherein the header hash information comprises header hash and hash method, the second computing device is configured to generate a new header hash with the hash method and compare the new header hash and the header hash received as in the header hash information from the security server so as to verify the integrity of the file header of the file to be decrypted.

15. The data security management system of claim 7, wherein when encrypting the file, the first computing device is configured to send parameters to the security server so that the security server creates a file header for the encrypted file.

16. A data security management system comprising:
a first computing device;
a second computing device; and
a security server in communication with the first and second computing devices; wherein:
the first computing device is configured to send an access authorization list to the security server and request an encryption key from the security server;
the security server is configured to send the encryption key to the first computing device;
the first computing device is configured to encrypt a file with the encryption key and share the encrypted file with the second computing device;
the second computing device is configured to request a decryption key from the security server;
the security server is configured to send the decryption key to the second computing device after verifying that the second computing device is being used by a user on the access authorization list; and
the second computing device is configured to decrypt the encrypted file with the decryption key.

17. The data security management system of claim 16, wherein the first computing device is configured to share the encrypted file with the second computing device through a storage, each access authorization list is bound with a unique encryption key, the security server comprises a key manager with an encryption key database, the security server is configured to assign a key ID to the encryption key, while the encryption key and the key ID are saved in the encryption key database.

18. A data security management method comprising:
sending an access authorization list to a security server from a first computing device and requesting an encryption key from the security server by the first computing device;
sending the encryption key to the first computing device from the security server;
encrypting a file with the encryption key by the first computing device and sharing the encrypted file with a second computing device;
requesting a decryption key from the security server by the second computing device;
sending the decryption key to the second computing device after verifying that the second computing device is being used by a user on the access authorization list by the security server; and
decrypting the encrypted file with the decryption key by the second computing device.
